(19) United States
(12) Patent Application Publication
(10) Pub. No.: US 2006/0011419 A1
(43) Pub. Date: Jan. 19, 2006

(54) Non-contact optical sensor switch assembly of elevators

(76) Inventor: Neng-Fu Chuang, Taoyuan City (TW)

Correspondence Address: BACON & THOMAS, PLLC, 625 SLATERS LANE, FOURTH FLOOR, ALEXANDRIA, VA, 22314, US

(21) Appl. No.: 10/889,089

(22) Filed: Jul. 13, 2004

(51) Int. Cl. B66B 13/14

(52) U.S. Cl. 187/316

(57) ABSTRACT

The present invention discloses a non-contact optical sensor switch assembly of elevators which comprises a plurality of switches equidistantly aligned with each other and disposed on a panel of an elevator, and each switch is an operation button for the elevator; a plurality of optical sensors disposed on the switches, such that before a finger touches the switches, the optical sensor is capable of detecting an approaching finger, and the switches are electrically coupled to a signal detect circuit of the elevator, and the signal detect circuit is coupled to a control circuit of the elevator; thereby, when the optical sensor senses the approaching finger, the optical sensor sends a detect signal to the signal detect circuit and the detect circuit sends the detect signal to the control circuit, such that the control circuit executes the corresponding operation according to an instruction given by pressing the switch.

### BACKGROUND OF THE INVENTION

1. Field of the Invention

The present invention relates to a switch assembly, more particularly to a non-contact optical sensor switch assembly of elevators.

2. Description of the Related Art

An elevator is a tool used by the general public, which can transport people or goods to different floors of a building quickly and thus is a very convenient tool. There is a plurality of switches on the panel of an elevator and each switch is a press button designated for the functions of going to a particular floor, opening the door or closing the door, etc., so that a user can press one of these buttons to select and execute an operation (such as selecting a switch to go to a particular floor).

However, there may be many passengers taking an elevator at the same time, and each passenger must select one of the press buttons for executing an operation (such as selecting a floor) before taking the lift. Therefore, the surface of these press buttons are touched by many people; if any of them is a carrier such as a severe acute respiratory syndrome (SARS) carrier or a tuberculosis carrier, etc) who has touched these buttons, then the next passenger may be infected by touching the same buttons. Thus, it is necessary to design and develop an elevator switch that can prevent infections.

### SUMMARY OF THE INVENTION

In view of the shortcomings of the aforementioned prior art that elevator passengers may be infected easily by touching the switches of an elevator, the inventor of the present invention based on years of experience on the technology and manufacture of electronic devices to conduct extensive researches and experiments to find a solution to the deficiency of the prior art and finally developed a non-contact optical sensor switch assembly to overcome the shortcoming derived from the aforementioned prior art.

Therefore, it is a primary objective of the present invention to provide a non-contact optical sensor switch assembly of elevator as to prevent elevator passengers from being infected by germs or bacteria by touching the switches of the elevator.

Since there is a plurality of switches equidistantly disposed on a panel of the elevator and each of these switches is for selecting a function of going to a particular floor, opening the door or closing the door, therefore an optical sensor is built into each of these switches to achieve the objective of the present invention. Before a user touches these switches by a finger, the optical sensors will detect the approaching finger. Since these switches are electrically connected to one of the signal detect circuits and each signal detect circuit is electrically connected to one of the control circuits of the elevator, therefore when the optical sensor of one of the switches detects the approaching finger, the optical sensor will send out a detect signal to the signal detect circuit and drive the signal detect circuit to send such detect signal to the control circuit, and then the control circuit will execute the operation according to the instruction given by the pressed button (such as an instruction for opening the door). Such arrangement does not require users to touch the switches on the panel of the elevator to select their desired operation (such as selecting a particular floor or selecting to open the door), and thus the present invention can avoid the possibility of being infected by touching the switches.

To make it easier for our examiner to understand the objective of the invention, its structure, innovative features, and performance, we use a preferred embodiment including but not limited to the attached drawings for the detailed description of the invention.

### BRIEF DESCRIPTION OF THE DRAWINGS

FIG. 1 is an illustrative view of the elevator according to the present invention.

FIG. 2 is a circuit block diagram of the present invention.

FIG. 3 is a circuit block diagram according to another preferred embodiment of the present invention.

FIG. 4 is a circuit block diagram according to another further preferred embodiment of the present invention.

### DETAILED DESCRIPTION OF THE PREFERRED EMBODIMENTS

The present invention relates to a non-contact optical sensor switch assembly for preventing elevator passengers from being infected by germs or bacteria by touching the switches of the elevator.

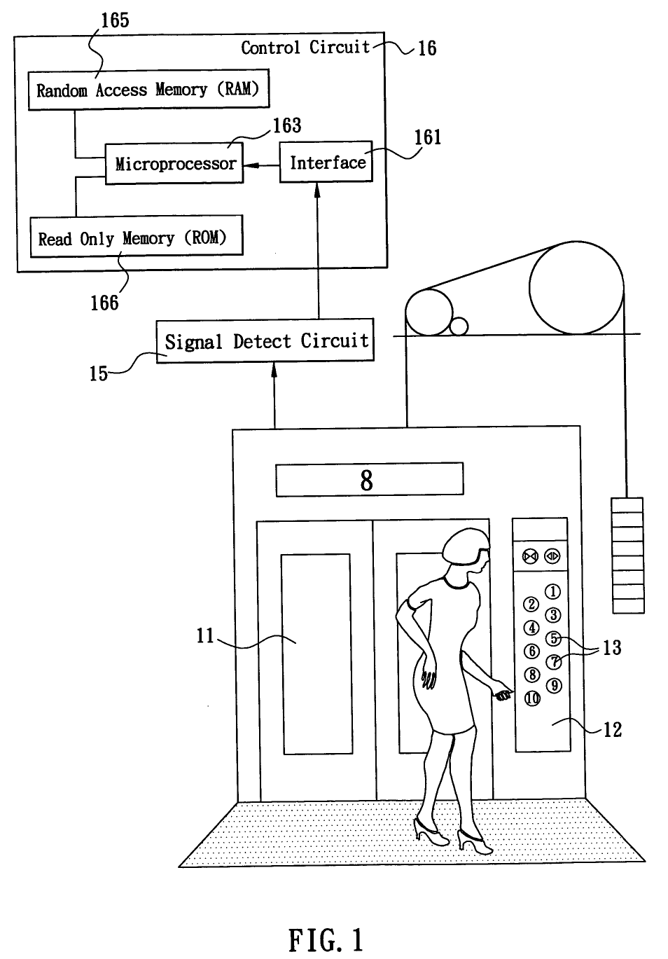

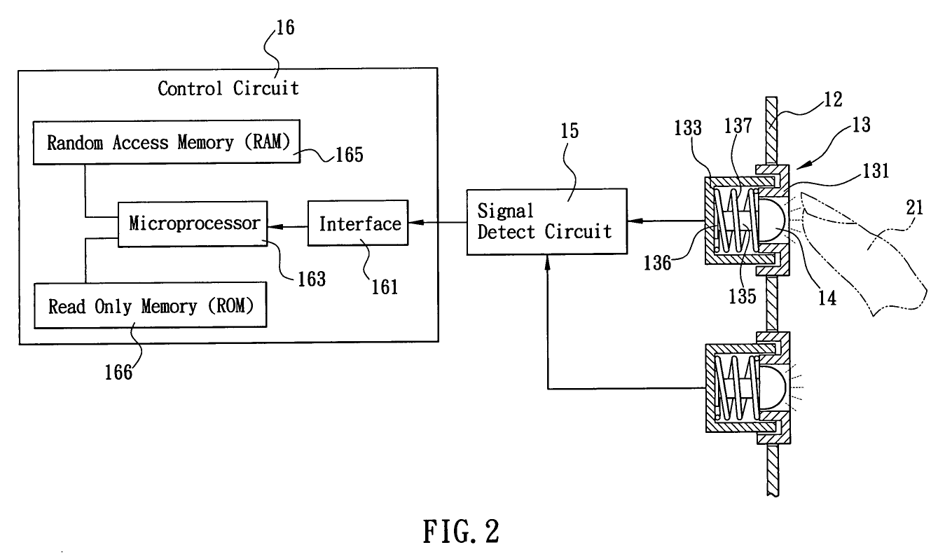

Please refer to FIGS. 1 and 2. The non-contact optical sensor switch assembly comprises a plurality of switches 13 equidistantly disposed on a panel 12 of an elevator 11 and each of these switches 13 is a press button for a user to select a particular floor, open the door, or close the door; an optical sensor 14 built into each of these switches 13, such that before a user touches these switches 13 by a finger 21, the optical sensors 14 will detect the approaching of the finger 21. Since these switches 13 are electrically connected to one of the signal detect circuits 15 of the elevator and the signal detect circuit 15 is electrically connected to one of the control circuits 16 of the elevator 11.

Please refer to FIGS. 1 and 2 again. With the assembly of the foregoing components, when the optical sensor 14 of one of the switches 13 detects the approaching of a finger 21, the optical sensor 14 will send out a detect signal to the signal detect circuit 15 as to drive the signal detect circuit 15 to send such detect signal to the control circuit 16, and then the control circuit 16 will execute the operation according to the instruction given by the pressed switch (such as an instruction for opening the door). Such arrangement does not require users to touch the switches 13 on the panel 12 of the elevator 11 to select the desired operation (such as selecting a particular floor or selecting to open the door), and thus the present invention can avoid the possibility of being infected by touching the switches 13.

Please refer to FIG. 2 again. Each switch 13 comprises a press section 131 and a bottom 133, wherein the press section 131 is movably coupled onto the bottom 133, such that when the press section 131 is pressed, the press section 131 will generate a back and forth linear movement sideway, and the press section 131 at its bottom has a press rod 135 extended towards the bottom 133, and the bottom 133 has an electric contact point 136 disposed therein at a position corresponding to the press rod 135, and the press rod 135 comes with a resilient device 137 such as a spring, such that when the press section 131 is pressed, the bottom of the press rod 135 presses on the electric contact point 136 to generate an electric connection. After the press section 131 is pressed, the press section 131 will resume its original position through the resilience of the resilient component 137.

Please refer to FIGS. 1 and 2 again. The control circuit 16 comprises an interface circuit 161, a microprocessor 163, a random access memory 165 and a read only memory 166, wherein the microprocessor 163 is electrically connected with the interface circuit 161, the random access memory 165 and a read only memory 166 and the interface circuit 161 is electrically connected with a signal detect circuit 15, and different operation programs of the elevator 11 are stored in the read only memory 166, such that the microprocessor 163 will execute the instructions of the corresponding operation program in the read only memory 166 according to the instructions given by the pressed switch 13.

Please refer to FIGS. 1 and 2. If the control circuit 16 receives many instructions from a plurality of different pressed switches 13 at a time, the control circuit will cancel all these instructions to prevent sensing any unintended instruction wrongly detected by the optical sensors 14 of these switches.

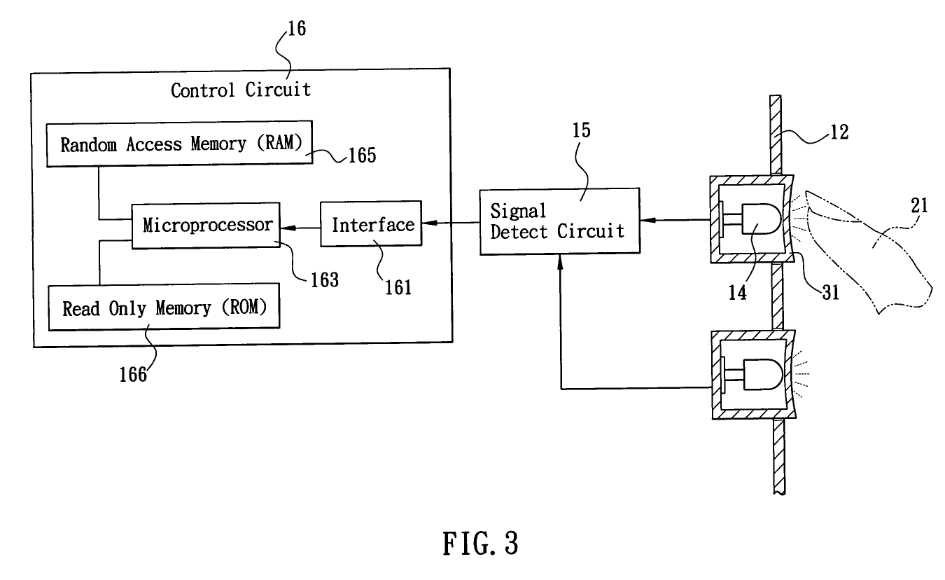

Please refer to FIGS. 1 and 3 for another preferred embodiment of the present invention. The panel 12 of the elevator 11 comprises a plurality of equidistantly aligned hollow shells 31, and each shell 31 has an optical sensor 14, so that before a user touches the shell 31 by a finger 21, the optical sensor 14 can detect the approaching finger 21. The optical sensors 14 are electrically connected to a signal detect circuit 15 of the elevator 11 and then the signal detect circuit 15 will send this detect signal to the control circuit 16, so that the control circuit 16 can execute the related operation according to the instruction of the detect signal (such as the instruction for opening the door).

Please refer to FIGS. 1 and 3. The control circuit 16 comprises an interface circuit 161, a microprocessor 163, a random access memory 165 and a read only memory 166, wherein the microprocessor 163 is electrically connected to the interface circuit 161, the random access memory 165 and the read only memory 166, and the interface circuit 161 is electrically connected to signal detect circuit 15, and the read only memory 166 stores different operation programs of the elevation 11 in the read only memory 166, such that the microprocessor 163 can execute the corresponding instructions of the operation program to proceed with the related operation according to the instruction of the detect signal of each optical sensor 14.

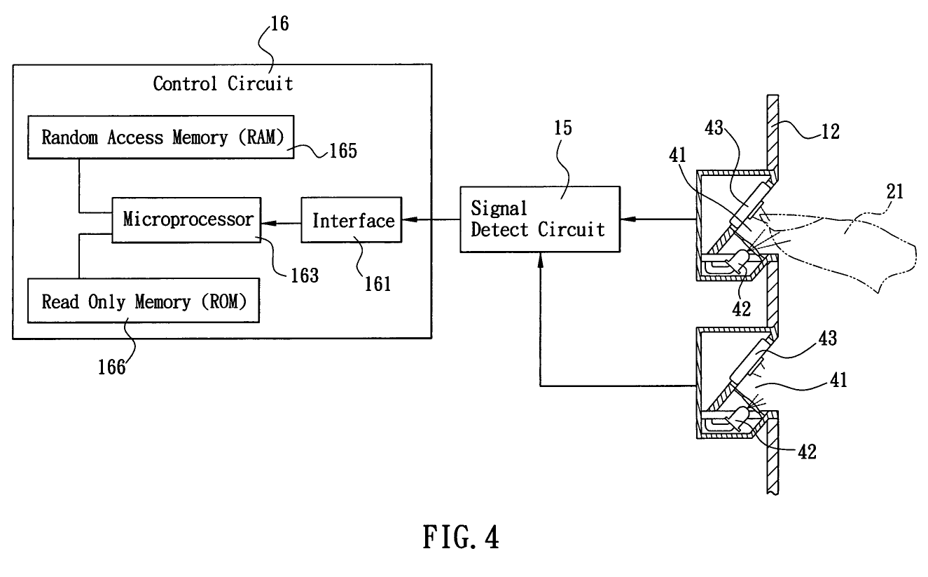

Please refer to FIGS. 1 and 4 for another preferred embodiment of the present invention. A plurality of recesses 41 equidistantly is disposed on the panel 12 of the elevator 11, and each recess has a light emitting device 42 such as a light emitting diode (LED) and a receiver 43 corresponding to the light emitting device 42, such that when a finger 21 is placed into the recess 41, the light emitted from the light emitting device 42 will be reflected to and received by the receiver 43. The receiver 43 is electrically connected to a signal detect circuit 15 of the elevator 11, and the signal detect circuit 15 is electrically connected to a control circuit 16 of the elevation 11.

If one of the receivers 43 receives the light emitted from the light emitting device 42, the receiver 43 will send out a detect signal to the signal detect circuit 15, so that the signal detect circuit 15 will send the detect signal to the control circuit 16 and the control circuit 16 will execute the corresponding operation according to the instruction of the detect signal (such as the instruction for opening the door).

Please refer to FIGS. 1 and 4. The control circuit 16 comprises an interface circuit 161, a microprocessor 163, a random access memory 165 and a read only memory 166; wherein the microprocessor 163 is electrically connected to the interface circuit 161, the random access memory 165 and the read only memory 166, and the interface circuit 161 is electrically connected to the signal detect circuit 15, and the read only memory 166 stores various operation programs of the elevator 11, such that the microprocessor 163 executes the corresponding instruction of the operation program in the read only memory 166 to proceed the related operation according to the detect signal of each receiver 43.

In summation of the description above, the non-contact optical sensor switch assembly of the present invention allows elevator passengers to select the desired operation (such as selecting a particular floor or selecting to open the door) without touching the switches 13 on the panel 12 of the elevator 11, and thus the present invention can avoid the possibility of being infected by germs or bacteria caused by touching the switches 13.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements.

What is claimed is:

1. A non-contact optical sensor switch assembly of elevators, comprising:
a plurality of switches, being equidistantly aligned with each other and disposed on a panel of an elevator, and said each switch being an operation button for said elevator;
a plurality of optical sensors, being disposed on said switches, such that before a finger touches said switches, said optical sensor is capable of detecting an approaching finger, and said switches being electrically coupled to a signal detect circuit of said elevator, and said signal detect circuit being coupled to a control circuit of said elevator;
thereby, when said optical sensor of one of said switches senses said approaching finger, said optical sensor sends a detect signal to said signal detect circuit and drives said detect circuit to send said detect signal to said control circuit, such that said control circuit executes the corresponding operation according to an instruction given by pressing said switch.

2. The non-contact optical sensor switch assembly of elevators of claim 1, wherein said control circuit comprises an interface circuit, a microprocessor, a random access memory and a read only memory, wherein said microprocessor is electrically coupled with said interface circuit, said random access memory and said read only memory, and said interface circuit is electrically coupled with a signal detect circuit, and a plurality of operation programs of said elevator is stored in said read only memory, such that said microprocessor executes a corresponding instruction of said operation program in said read only memory according to an instruction given by pressing said switch.

3. A non-contact optical sensor switch assembly, comprising:
a plurality of hollow shells, being equidistantly aligned with each other and disposed on a panel of an elevator;
a plurality of optical sensors, being disposed on said shells, such that before a finger touches said shells, said optical sensor is capable of detecting an approaching finger, and said switches being electrically coupled to a signal detect circuit of said elevator, and said signal detect circuit being coupled to a control circuit of said elevator;
thereby, when said optical sensor of one of said shells senses said approaching finger, said optical sensor sends a detect signal to said signal detect circuit and drives said detect circuit to send said detect signal to said control circuit, such that said control circuit executes the corresponding operation according to an instruction given by pressing said switch.

4. The non-contact optical sensor switch assembly of claim 3, wherein said control circuit comprises an interface circuit, a microprocessor, a random access memory and a read only memory, wherein said microprocessor is electrically coupled with said interface circuit, said random access memory and said read only memory, and said interface circuit is electrically coupled with a signal detect circuit, and a plurality of operation programs of said elevator is stored in said read only memory, such that said microprocessor executes a corresponding instruction of said operation program in said read only memory according to an instruction given by pressing said switch.

5. A non-contact optical sensor switch assembly, comprising:
a panel, disposed on an elevator and having a plurality of recesses disposed equidistantly with each other, and said each recess comprises a light emitting device and a receiver corresponding to said light emitting device, such that when a finger is placed in said recess, said light emitting device emits a light and reflects said light from said finger to said receiver and said receiver receives said light, and said receiver is electrically coupled to a signal detect circuit, and said signal detect circuit is electrically coupled to a control circuit of said elevator;
thereby when one of said receivers receives said light emitted from said light emitting device, said receiver sends a detect signal to said signal detect circuit such that said signal detect circuit sends said detect signal to said control circuit and said control circuit executes the corresponding operation according to an instruction of said detect signal.

6. The non-contact optical sensor switch assembly of claim 5, wherein said control circuit comprises an interface circuit, a microprocessor, a random access memory and a read only memory, wherein said microprocessor is electrically coupled with said interface circuit, said random access memory and said read only memory, and said interface circuit is electrically coupled with a signal detect circuit, and a plurality of operation programs of said elevator is stored in said read only memory, such that said microprocessor executes a corresponding instruction of said operation program in said read only memory according to an instruction given by pressing said switch.
